(19) United States
(12) Patent Application Publication
(10) Pub. No.: US 2009/0254401 A1
(43) Pub. Date: Oct. 8, 2009

(54) SYSTEM AND METHOD FOR CREATING A CUSTOM ASSESSMENT PROJECT

(75) Inventor: Paul BLANCHARD, Montreal (CA)

Correspondence Address: OSLER, HOSKIN & HARCOURT LLP (Iscopia), 1000 DE LA GAUCHETIERE STREET WEST, SUITE 2100, MONTREAL, QC, H3B 4W5, CA

(73) Assignee: ISCOPIA SOFTWARE INC., Montreal (CA)

(21) Appl. No.: 12/419,121

(22) Filed: Apr. 6, 2009

Related U.S. Application Data
(60) Provisional application No. 61/042,525, filed on Apr. 4, 2008.

(51) Int. Cl. G06Q 10/00

(52) U.S. Cl. 705/8; 705/7

(57) ABSTRACT

A method of creating a custom assessment project is disclosed. The method comprises selecting a template assessment project that includes modules adapted for interaction with a candidate to be assessed. The modules are linked in a workflow defining a sequence in which the candidate interacts with the modules. The template assessment project also includes a factor associated with at least one of the modules and a construct associated with the factor for evaluating the candidate. The method further comprises modifying at least one of the modules, the workflow, the factor, and the construct in response to user interaction; and updating at least another one of the modules, the workflow, the factor, and the construct without user interaction. A system and a computer readable storage medium for creating a custom assessment project are also disclosed.

### CROSS-REFERENCE

The present application claims priority to U.S. Provisional Patent Application No. 61/042,525 filed Apr. 4, 2008, the entirety of which is incorporated herein by reference. The present application is related to International Patent Application No. PCT/CA2007/001853 filed Oct. 16, 2007, the entirety of which is incorporated herein by reference.

### COPYRIGHT NOTICE

Contained herein is material that is subject to copyright protection. The copyright owner has no objection to the facsimile reproduction of the patent disclosure by any person as it appears in the Patent and Trademark office patent files or records, but otherwise reserves all rights to the copyright whatsoever.

### FIELD OF THE INVENTION

The present invention relates to a system and method for creating a custom assessment project for assessment of candidates.

### BACKGROUND OF THE INVENTION

Assessment of candidates for recruiting or promoting, job description, and learning management purposes, conventionally involved interviewing, lecturing or otherwise talking to individuals as well as possibly subjecting them to written tests or other exercises.

Certain aspects of candidate assessment have been facilitated by computer networking technology such as the Internet. For example, employers or recruiters can post job openings online and candidates can apply online for these openings.

Recently, online assessment tools for recruiting or promoting purposes have been developed. Such online assessment tools provide interfaces for interaction with candidates. To achieve maximum reliability, every time a candidate is to be assessed for a new job opening, the online assessment tools have to be modified. In order to achieve good reliability, a new assessment project has to be created for every new job opening. Given the high number and the complexity of the candidate aspects assessed by the online tools, the task of creating a new assessment project can be cumbersome and time consuming.

There is therefore a need in the art for a method and system for facilitating the creation of assessment projects.

### SUMMARY OF THE INVENTION

It is an object of the present invention to provide a method of creating a custom assessment project. The method comprises selecting a template assessment project from a database. The template assessment project includes a first module and a second module, the first and second modules being adapted for interaction with a candidate to be assessed; the first module being linked to the second module in a workflow, the workflow defining a sequence in which the candidate to be assessed interacts with the first and second modules; a factor associated with at least one of the first and second modules; a construct associated with the factor for evaluating an aspect of the candidate. The method also comprises modifying at least one of the first module, the second module, the workflow, the factor, and the construct in response to user interaction; and updating at least another one of the first module, the second module, the workflow, the factor, and the construct without user interaction in response to modifying the at least one of the first module, the second module, the workflow, the factor, and the construct.

In another aspect, modifying at least one of the first module, the second module, the workflow, the factor, and the construct in response to user interaction is achieved by a user interface.

In another aspect, updating at least another one of the first module, the second module, the workflow, the factor, and the construct without user interaction in response to modifying the at least one of the first module, the second module, the workflow, the factor, and the construct is achieved by a customisation tool.

In another aspect, the invention provides a system for creating a custom assessment project. The system comprises a database storing at least one template assessment project; a selection component for selecting a template assessment project from the database. The template assessment project includes a first module and a second module, the first and second modules being adapted for interaction with a candidate to be assessed, the first module being linked to the second module in a workflow, the workflow defining a sequence in which the candidate to be assessed interacts with the first and second modules; a factor associated with at least one of the first and second modules; a construct associated with the factor for evaluating an aspect of the candidate. The system also comprises an interface allowing a user to modify at least one of the first module, the second module, the workflow, the factor, and the construct; and a customisation tool for updating at least another one of the first module, the second module, the workflow, the factor, and the construct without user interaction in response to modifying the at least one of the first module, the second module, the workflow, the factor, and the construct.

In another aspect, the invention provides a computer readable storage medium containing program code for execution by a computing entity to implement a method of creating a custom assessment project. The method comprises selecting a template assessment project from a database. The template assessment project includes a first module and a second module, the first and second modules being adapted for interaction with a candidate to be assessed; the first module being linked to the second module in a workflow, the workflow defining a sequence in which the candidate to be assessed interacts with the first and second modules; a factor associated with at least one of the first and second modules; a construct associated with the factor for evaluating an aspect of the candidate. The method also comprises modifying at least one of the first module, the second module, the workflow, the factor, and the construct in response to user interaction; and updating at least another one of the first module, the second module, the workflow, the factor, and the construct without user interaction in response to modifying the at least one of the first module, the second module, the workflow, the factor, and the construct.

Additional and/or alternative features, aspects, and advantages of the embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 illustrates an architecture providing an online assessment system for performing assessment of candidates in accordance with an embodiment of the invention;

FIG. 2 illustrates components enabling interaction between a client computer and an assessment server;

FIG. 3 illustrates an architecture to develop and customise an assessment project;

FIG. 4 illustrates a sample assessment project;

FIG. 5 illustrates modules and constructs associated with factors of the sample assessment project of FIG. 4;

FIG. 6 illustrates a factor weight table and a construct weight table of the sample assessment project of FIG. 4;

FIG. 7 illustrates a flowchart of a method of calculating a construct score of the sample assessment project of FIG. 4;

FIG. 8 illustrates a flowchart of a method of calculating a general score of the sample assessment project of FIG. 4;

FIG. 9 illustrates a customisation tool and a sample custom assessment project produced by the customisation tool from a sample template assessment project;

FIGS. 10 and 11 illustrate a flowchart of a method of updating a custom assessment project;

FIG. 12 illustrates an example of a template assessment project for a nurse job;

FIG. 13 illustrates an example of a custom assessment project for a nurse job created from the template assessment project of FIG. 12;

FIG. 14 illustrates an embodiment of a first window of the customisation tool;

FIG. 15 illustrates an embodiment of a second window of the customisation tool;

FIG. 16 illustrates an embodiment of a third window of the customisation tool; and

FIG. 17 illustrates an embodiment of a fourth window of the customisation tool.

In the drawings, embodiments of the invention are illustrated by way of example. It is to be expressly understood that the description and drawings are only for purposes of illustration and as an aid to understanding. They are not intended to be a definition of the limits of the invention.

### DETAILED DESCRIPTION OF THE PREFERRED EMBODIMENTS

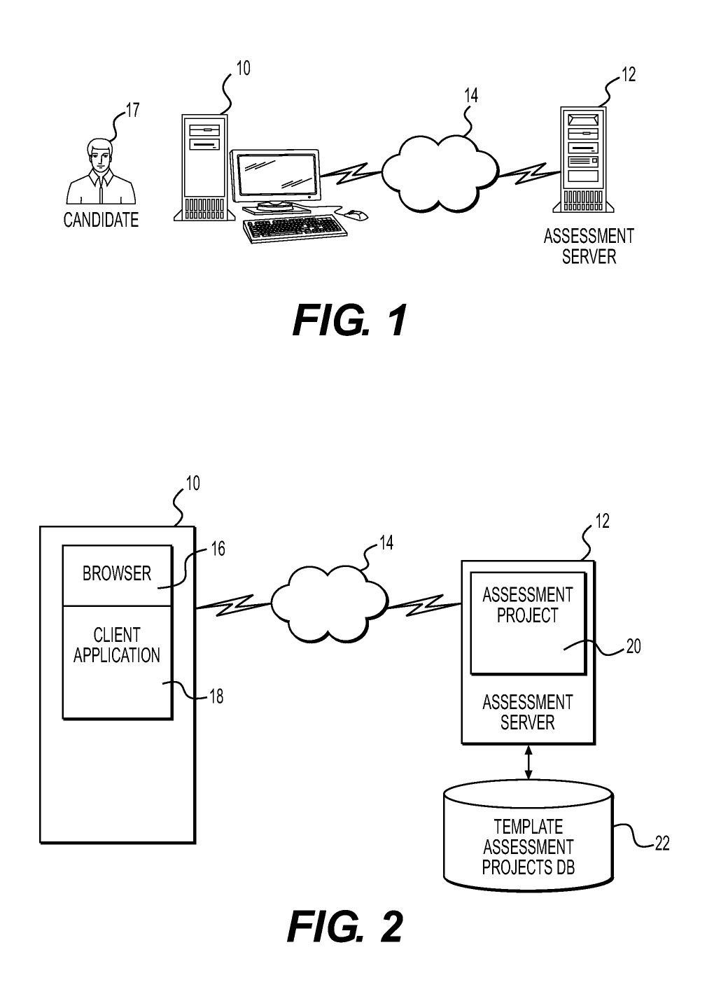

FIG. 1 illustrates an embodiment of an architecture providing an online assessment system for performing assessment, and in particular assessing a person's suitability for a certain job. The access to the assessment system relies on Internet-based services using either software as service model or other business models, such as software distribution. The architecture comprises a computing entity, in this case an assessment server 12, connected to a data network 14 and implementing a data network site accessible via the data network 14. In this example, the data network 14 is the Internet and the data network site is a website. Although shown as being one element, the assessment server 12 may be implemented by one or more computers (e.g., a server farm or other group of networked computers) forming a computing entity. The assessment server can be implemented by using various software technologies, such as web-oriented technologies. In an embodiment, the system is developed using the object-oriented Java language and more specifically the Java 1.5 and J2EE platform as well as Jboss and Adobe® LifeCycle. Other technologies, such as Hibernate (for the database abstraction), jBPM (for the workflow), Groovy, Drools and a database operated under MySQL5 technology are also used. The resource management and the plug-in management are carried out using JMX and OSGI technologies respectively.

A candidate 17 can use a client computer 10 to interact with the assessment server 12 over the data network 14. The client computer 10 may comprise a computing entity; a display, a speaker, and possibly one or more other output devices; and one or more input devices such as a keyboard, a mouse, a microphone, a stylus, and/or a touchscreen. The computing entity may be implemented by a combination of hardware and software. In various embodiments, the client computer 10 may be a personal computer (e.g., a desktop or laptop computer) or a workstation, or it may be a networked personal digital assistant (PDA) or other wireless communication device having access to the data network 14 and having computing functionality.

The candidate 17 can use the client computer 10 to access the website implemented by the assessment server 12. Access to the website can be direct (i.e. without requiring any log-on procedure from the candidate 17) or requires the candidate 17 to log on to the website by providing identification information (e.g., a special code or personal information such as, for example, his/her name, date of birth, email address) and authentication information (e.g. a password).

FIG. 2 is a block diagram illustrating an example of implementation of components enabling interaction between the client computer 10 and the assessment server 12. Generally, interaction between the client computer 10 and the assessment server 12 can be effected via an exchange of signals over the data network 14 (e.g. signals generated by the assessment server 12 to allow the client computer 10 to implement a user interface for interacting with the candidate 17; signals generated by the client computer 10 that convey information describing inputs made by the candidate 17 using the one or more input devices of the client computer 10; etc.).

In this embodiment, the client computer 10 implements a browser 16 that includes integrally or as a plug-in a client application 18 for managing building blocks of an assessment project. The client application 18 can be Adobe (MacroMedia) Flash Player or any other suitable application. It is also contemplated that the client application 18 could also be based on Action Script 3, Flex 3.0, HTML, Ajax and Java Script technologies.

The assessment server 12 implements at least one assessment project 20 with which the client computer 10 interacts. The assessment server 12 accesses a database 22 in which template assessment projects are stored. The database 22 can be run on the assessment server 12 or on a different server. An assessment project 20 can be associated, for example, with a given job (position) type. Therefore, there may be as many assessment projects as there are job types for which openings exist. Examples of job types include: nurse, sales clerk, security guard, store manager, secretary, file clerk, among many others, all of which may be associated with different assessment projects.

In an embodiment, an assessment project 20 includes a profile and a workflow. The profile defines what is to be measured and the workflow defines how to measure it. The profile includes one or more constructs associated with modules of the workflow. Typically, the modules convey information (graphical and/or textual) to the candidate 17 and can receive information from the candidate 17 as he/she interacts with the assessment project 20.

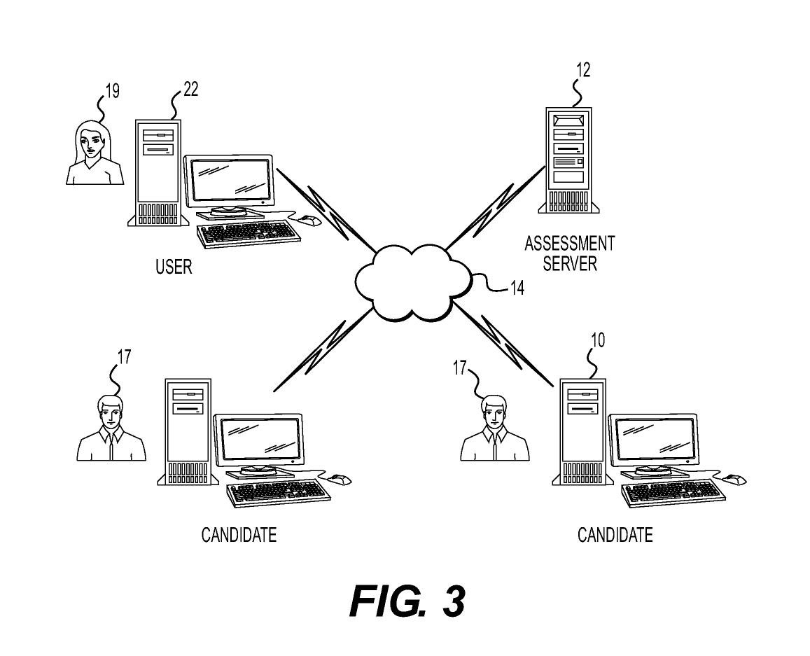

FIG. 3 is block diagram illustrating an architecture that can be used to customise an assessment project 20. A user 19 can use a client computer 22 to interact with the assessment server 12 over the data network 14. The client computer 22 may comprise a computing entity; a display, a speaker, and possibly one or more other output devices; and one or more input devices such as a keyboard, a mouse, a microphone, a stylus, and/or a touchscreen. The computing entity may be implemented by a combination of hardware and software. In various embodiments, the client computer 22 may be a personal computer (e.g. a desktop or laptop computer) or a workstation, or it may be a networked personal digital assistant (PDA) or other wireless communication device having access to the data network 14 and having computing functionality.

In this embodiment, in addition to implementing the one or more assessment projects 20, the assessment server 12 also implements a customisation tool that allows the user 19 to customise template assessment projects to render them more relevant to the candidates and accurate when assessing candidates. In this example, the customisation tool and the assessment projects 20 reside on the same server 12. Therefore, as the user 19 is working with the customisation tool to produce a custom assessment project from a template assessment project, candidates 17 can use client computers (such as the client computer 10) to interact with other assessment projects 20 on the same server 12. Note that, in other examples, it is equally feasible to run on different servers the assessment projects 20 and the customisation tool to create custom assessment projects 20.

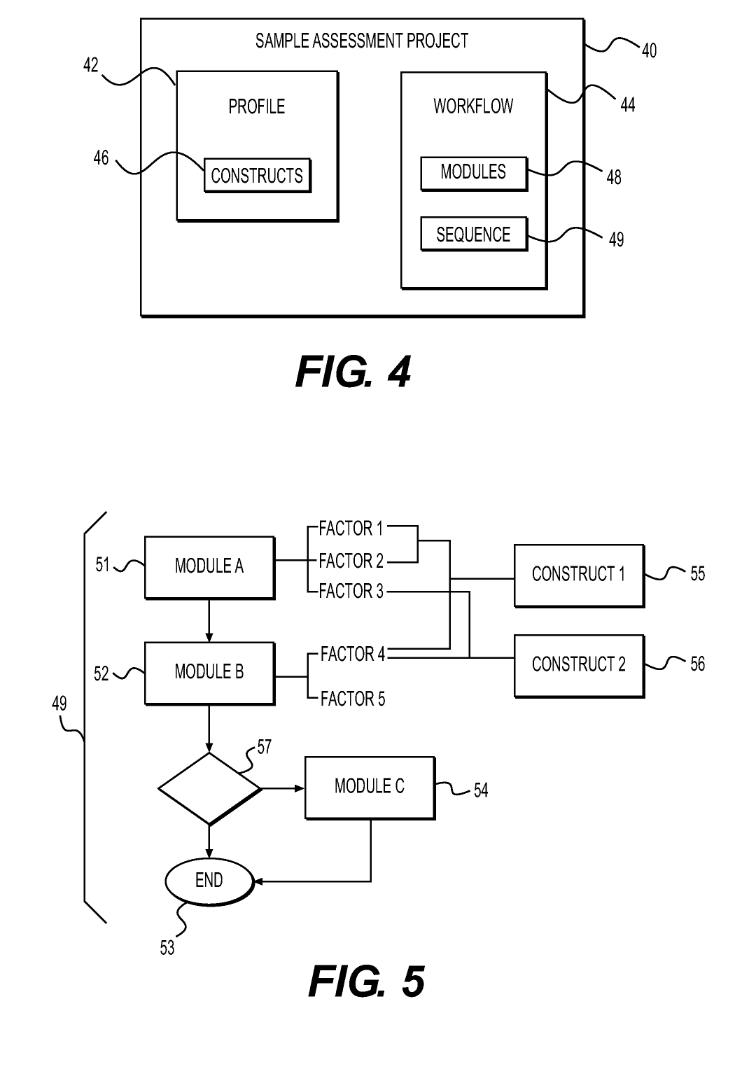

As shown in FIG. 4, a sample assessment project 40 includes a profile 42 and a workflow 44. The profile 42 defines what is to be measured and the workflow 44 defines how to measure it. The profile 42 includes one or more constructs 46 associated with modules 48 of the workflow 44.

The one or more constructs 46 of the profile 42 describes what is to be measured during a candidate assessment. A construct is directed to the assessment of an aspect of a candidate. For example, a construct can be directed to the assessment of a competency, a skill, an experience, a certification, knowledge, and an aptitude. Each one of the constructs contains sub-elements also called content. Each sub-element (or content) can include, but is not limited to, for example, interview questions, development suggestions and behavioural anchors. In an embodiment, a construct can depend from another construct. For example, a first construct can rely on a second construct to measure an aspect of the candidate. In such case, the first construct depends from the second construct.

The workflow 44 contains modules 48 ordered in a sequence 49. Each of the modules 48 is a component of the assessment project 40 with which the candidate 17 can interact. By “interact” it is meant that the candidate 17 will obtain some type of information from the module 48 and optionally will input some information into that module 48. For examples, a module can be directed to psychometric assessments, realistic job previews, background checks and biodata surveys. This list is non-limitative and other examples of modules can be found in the International Patent Application No. PCT/CA2007/001853.

In an embodiment, at least some of the modules 48 comprise a priority criterion and a dependency criterion. The priority criterion defines a priority of a module 48 with respect to another module 48 in the sequence 49. For example, a highest priority criterion value of one of a first priority criterion value of a first module and a second priority criterion value of a second module determines which one of the first and second modules is positioned first in the sequence. A priority criterion can be based on, for example, a cost of a module, legal constraints, and psychometric rules. The dependency criterion defines a dependency of a module with respect to another module. For example, a dependency criterion of a first module defines that the first module depends from a second module. According to the dependency criterion, the second module is positioned before the first module in the sequence.

The workflow 44 selectively invokes the modules 48 according to the sequence 49 and determines an order in which the modules 48 will be run, makes decisions as to whether certain modules 48 will be run or will not be run, including decisions on branching operations. In a branching operation, the workflow 44 makes a decision about an action to be carried out on a basis of characteristics of the candidate 17 or on a basis of a manner in which the candidate 17 has interacted with the assessment project 40. An example of a branching operation is a situation where the candidate 17 is an employee of a company applying to a job opening within the same company and the workflow 44 will take a workflow branch specifically designed for internal candidates. Another example of a branching operation is a situation where the candidate 17 obtains an insufficient score at initial tests such that there is no reason to continue the assessment. Therefore, on the basis of scores, the workflow 44 will terminate the assessment by invoking a farewell message.

FIG. 5 shows an example of modules and constructs of the assessment project 40 associated with factors. In this example, modules 51, 52, 54, and an end of the assessment 53 are ordered in a sequence 49. The candidate 17 will interact with the modules 51, 52, and 54, according to the sequence 49 during the assessment. In addition, the sequence also comprises a decision point 57 positioned between the module 52 and the end of the assessment 53 and the module 54. The decision point 57 includes a criterion to make a decision with respect to which one of the end of the assessment 53 and the module 54 the candidate 17 will be directed to when his interaction with module 52 is completed. For example, when the candidate 17 has completed his interaction with module 52, the decision point can compare the criterion with at least one of Factor 1, Factor 2, Factor 3, Factor 4, and Factor 5 and make the decision that the candidate 17 will proceed with the module 54 if he/she obtains a sufficient score.

The module 51 is associated with Factor 1, Factor 2, and Factor 3, and the module 52 is associated with Factor 4 and Factor 5. A factor, for example, Factor 1, Factor 2, Factor 3, Factor 4, and Factor 5, is a measure of the interaction of the candidate 17 with a module, in this example module 51 or module 52. For example, module 51 can implement a personality test with nine questions, Q1, Q2, Q3, Q4, Q5, Q6, Q7, Q8, and Q9. In this example, Factor 1 is associated with the module 51 by measuring an answer of the candidate 17 to the questions Q1, Q2, and Q3. Measuring the answer of the candidate 17 to a question can be made for example, by assigning a score to each predefined answer of a plurality of predefined answers. An example of association between the module 51 and Factor 1, Factor 2, and Factor 3 can be:
Q1 and Q2 and Q3=>Factor 1
Q4 and Q5 and Q6=>Factor 2
Q7 and Q8 and Q9=>Factor 3

The association of the module 51 and Factor 1, Factor 2, and Factor 3 described above is an example. Any kind of association between a module and a factor is also contemplated.

Construct 55 is associated with Factor 1, Factor 2, and Factor 4. Construct 56 is associated with Factor 3 and Factor 4. The constructs 55 and 56 define what is to be measured during the assessment of the candidate 17. In this example, the construct 55 is measured by modules 51 and 52 since the construct 55 is associated with Factor 1, Factor 2, and Factor 4. In this example, the construct 56 is also measured by modules 51 and 52 since the construct 56 is associated with Factor 3 and Factor 4.

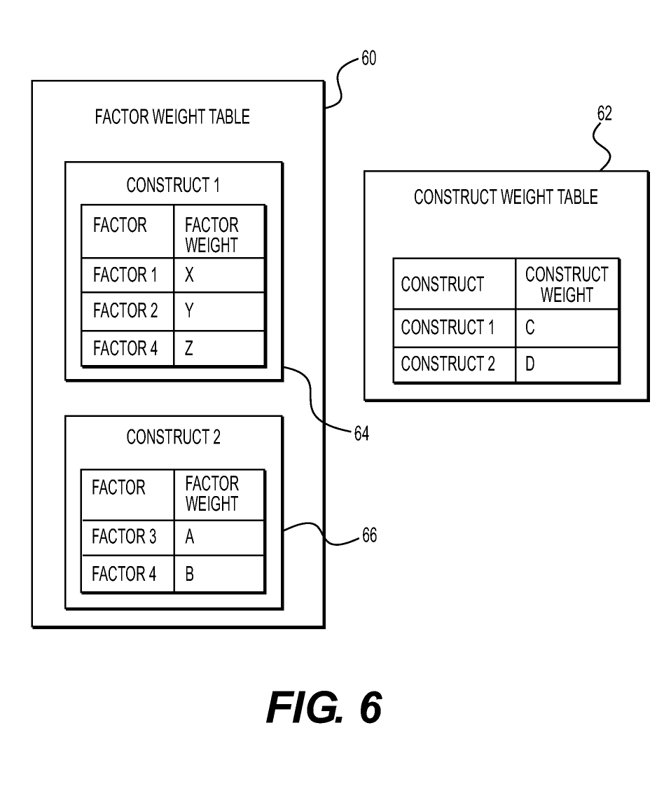

FIG. 6 illustrates a factor weight table 60 and a construct weight table 62 of the assessment project 40. The factor weight table 60 contains a sub-table 64 and a sub-table 66. The sub-table 64 comprises factor weights associated with factors, the factor weights are used for the calculation of a construct score, also called construct scoring algorithm. In this example, the factor weights of the sub-table 64 are X, Y, and Z and are associated with Factor 1, Factor 2, and Factor 3, respectively. The factor weights of the sub-table 64 are used for the calculation of a construct score for the construct 55. The sub-table 66 also comprises factor weights associated with factors. In this example, the factor weights of the sub-table 66 are A and B and are associated with Factor 3 and Factor 4, respectively. The factor weights of the sub-table 66 are used for the calculation of a construct score for the construct 56. As can be seen, it is contemplated that the same factor, in this case factor 4, can have different weights for different constructs.

The construct weight table 62 comprises construct weights associated with constructs used for the calculation of a general score, also called recommendation algorithm. In this example, the construct weight table 62 comprises construct weights C and D associated with the construct 55 and the construct 56, respectively.

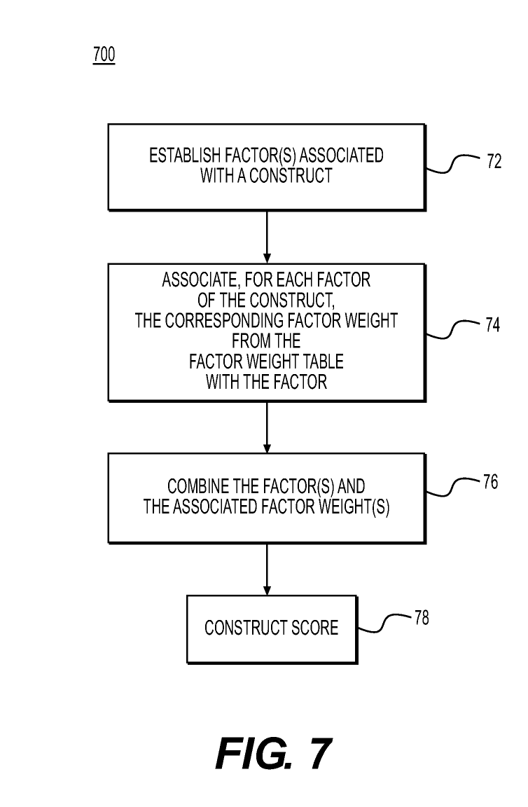

Reference is now made to FIG. 7, where the steps of a method of calculating a construct score of the assessment project 40, according to an embodiment, are shown. A construct score is associated to a construct and measure a score of the candidate 17 for an aspect of the candidate 17 assessed by the construct. The method 700 is undertaken for each construct score to be calculated. The method 700 begins at step 72 where the factors associated with a construct are established, for example, by referring to a sub-table of the factor weight table 60. Next, at step 74, for each one the factors of the construct, a corresponding factor weight is associated with the factor, for example, by referring to the sub-table of the factor weight table 60. Next, at step 76, the factors and their associated factor weights are combined to generate, at step 78, the construct score.

For example, according to the method 700 and to the sub-table 64, a construct score of the construct 55 is calculated by associating Factor 1 with a factor weight X, Factor 2 with a factor weight Y, and Factor 3 with a factor weight Z. Next, each one of Factor 1, Factor 2, and Factor 3 associated with their respective factor weights, are combined to generate the construct score of the construct 55. An example of combination of Factor 1, Factor 2, and Factor 3 associated with their respective factor weights for generating a construct score of the construct 55 can be:

Factor 1*40%+Factor 2*20%+Factor 3*40%=construct score of the construct 55, wherein X=40%, Y=20%, and Z=40%.

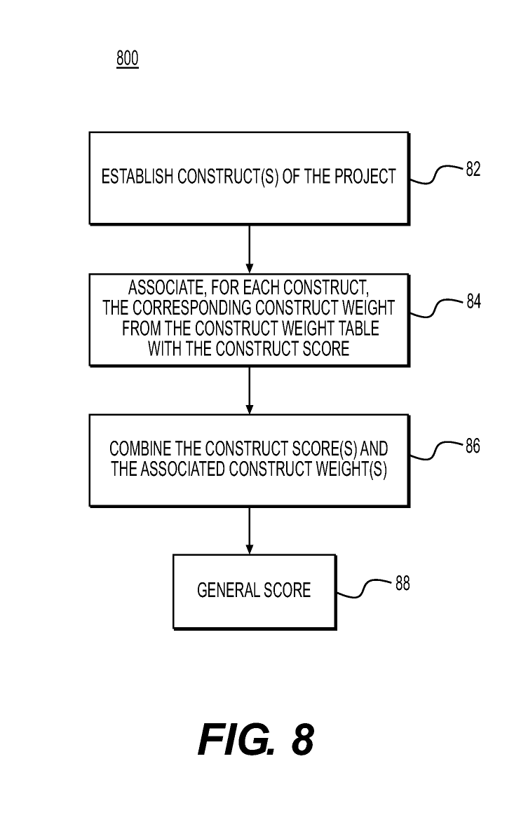

Reference is now made to FIG. 8, where the steps of a method of calculating a general score of the assessment project 40, according to an embodiment, are shown. A general score measures a score of the candidate 17 for all the aspects of the candidate 17 assessed by the constructs of an assessment project. The method 800 is undertaken when the candidate 17 has completed the assessment. The method 800 begins at step 82 where the constructs associated with the project are established, for example, by referring to the construct weight table 62. Next, at step 84, for each one the constructs of the project a construct score is established, for example according to the method 700. A corresponding construct weight is associated with the construct score, for example, by referring to the construct weight table 62. Next, at step 86, the construct scores and their associated construct weights are combined to generate, at step 88, the general score.

For example, according to the method 800 and to the construct weight table 62, a general score is calculated by associating a construct score of construct 55 with a construct weight C and a construct score of construct 56 with a construct weight D. Next, each one of the construct scores of the constructs 55 and 56 associated with their respective weights, are combined to generate the general score. An example of combination of the construct scores of the constructs 55 and 56 associated with their respective construct weights for generating a general score can be:

Construct 55*40%+Construct 56*60%=general score, wherein C=40%, and D=60%.

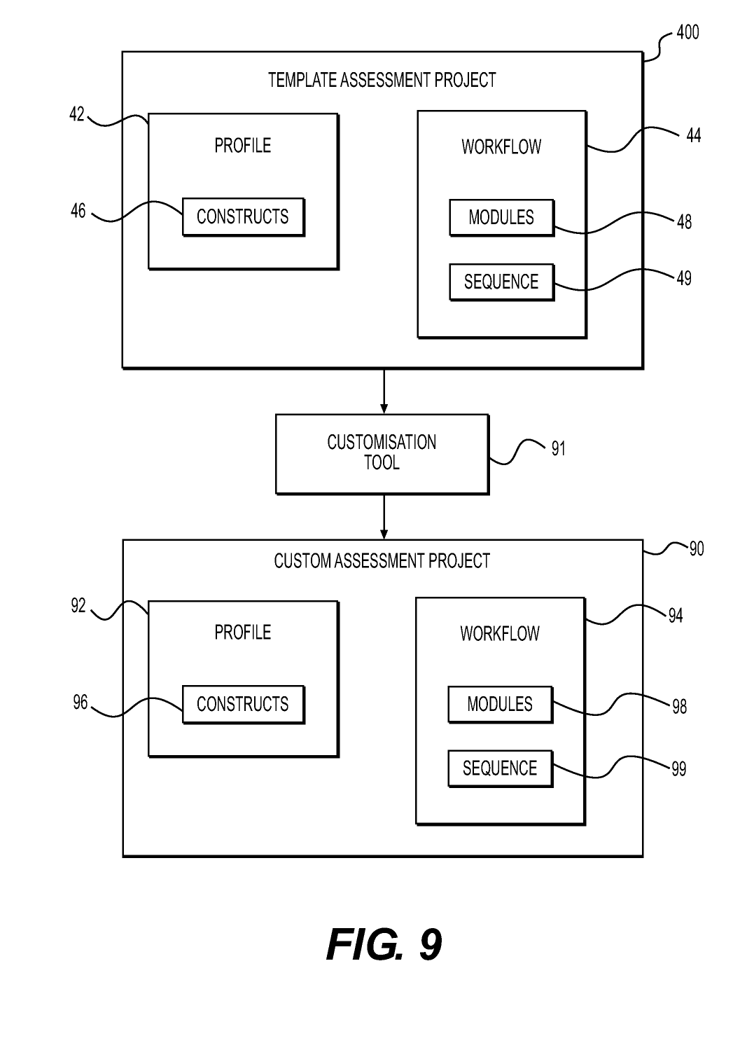

Turning now to FIGS. 9 to 11, a method of customising a template assessment project 400 to create a custom assessment project 90 will be described. For simplicity, the template assessment project 400 is defined as having the profile 42, workflow 44, constructs 46, modules 48, sequence 49 and the associated factors and weights of sample assessment project 40. When an assessment to be performed corresponds to a template assessment project 400 stored in the database 22, the candidate 17 interacts with the template assessment project 400. When an assessment to be performed does not correspond directly to a template assessment project 400, the template assessment project 400 is customised using the customisation tool 91 as described below to create a custom assessment project 90. The candidate 17 then interacts with the custom assessment project 90.

FIG. 9 illustrates the template assessment project 400, the customisation tool 91, and the custom assessment project 90. In an embodiment, the customisation tool 91, includes a software-implemented customisation tool unit designed to interact via the data network with the user 19 at the client computer 22, such as to remotely receive commands and cause display on the client computer 22 of information for the user 19 to see.

The custom assessment project 90 is created by the customisation tool 91 from the template assessment project 400 selected by the user 19. In an embodiment, the customisation tool 91 does not affect the template assessment project 400. The customisation tool 91 creates an override file that stores all the modifications to the custom assessment project 90. The override file is initially a copy of the template assessment project 400. As with the template assessment project 400, the custom assessment project 90 includes a profile 92 and a workflow 94. The profile 92 includes one or more constructs 96 associated with modules 98 of the workflow 94 according to a sequence 99.

The customisation of each one of a profile and a workflow is carried out through the customisation tool 91 and occurs after the template assessment project 400 is assigned to the custom assessment project 90. To carry out the customisation, the user 19 can modify the custom assessment project 90, via a graphical user interface provided by the customisation tool 91, by modifying the profile 92 or the workflow 94. In an embodiment, the customisation tool 91 can limit the modifications that the user 19 can make to certain aspects of the profile 92 or to certain aspects of the workflow 94. For example, some but not all of the modules 98 can be modified. Many reasons exist for not allowing the user 19 to modify a module such as to ensure that a test respect psychometric rules for example.

The user 19 can modify the workflow 94 by modifying at least one of the modules 98 such as by adding, removing or modifying questions contained in the at least one of the modules 98 for example. The user 19 can also modify a priority criterion or a dependency criterion of a module such as by changing its value for example. The user 19 can also add or remove a module to add or remove a particular test implemented into one or more modules for example. The user 19 can also modify the sequence 99 in which the candidate 17 to be assessed interacts with the modules 98. The user 19 can add or remove a decision point and also modify the value of the criterion of the decision point. In addition, the user 19 can modify an association between a module and a factor such as by adding, removing or modifying a relation between a question of a module and a factor for example. The user 19 can also modify the factors. The user 19 can modify the factor weight table 60 by modifying the values of the factor weights of the sub-tables 64 and 66.

The user can modify the constructs 96. The user 19 can modify an association between a construct and a factor such as by adding, removing or modifying a relation between a construct and a factor for example. The user 19 can also add or remove a construct. The user 19 can also modify the combination of factors with their respective factor weights thereby modifying a score of a construct. The user 19 can also add or remove a score of a construct by modifying the values of the factor weights of the sub-tables 64 and 66. In addition, the user 19 can modify the construct weight table thereby modifying a general score.

All the modifications to the custom assessment project 90 listed above are examples. Any kind of modification that could be made to an assessment project is contemplated.

The customisation tool 91 tracks the one or more modifications to the custom assessment project 90 made by the user 19. A modification from the user 19 to a part of the custom assessment project 90 generally impacts another part of the custom assessment project 90. In response to the one or more modifications by the user 19, the customisation tool 91 updates the custom assessment project 90 thereby avoiding the user 19 to manage all the consequences of a modification on the custom assessment project 90. The customisation tool 91 does not require to re-engineer or reprogram a template assessment project 400 each time a modification is made thereby avoiding expensive development costs to meet specific evaluation process requirements. The update of the custom assessment project 90 by the customisation tool 91 can be done automatically. It is contemplated that the customisation tool 91 could inform the user of the modifications made by the customisation tool 91 and requires the user 19 to confirm each one of the modifications proposed by the customisation tool 91, however this confirmation by the user 19 is not considered to be user interaction for purposes of updating the custom assessment project 90.

The customisation tool 91 updates the custom assessment project 90 in response to a modification to the custom assessment project 90 by the user 19. To carry out the update, the customisation tool 91 modifies the custom assessment project 90 by modifying at least one of the profile 92 and the workflow 94. In an embodiment, the customisation tool 91 can limit modifications to certain aspects of the profile 92 or the workflow 94. For example, some but not all of the modules 98 can be modified. For example, a module can be previously defined as de-constructible or not in the template assessment project 400. For example, if a module is de-constructible, the customisation tool 91 can remove questions not required to generate factors.

The customisation tool 91 can modify the workflow 94 by modifying at least one of the modules 98 such as by adding, removing or modifying questions contain in the at least one of the modules 98 for example. The customisation tool 91 can also modify a priority criterion or a dependency criterion of a module such as by changing its value for example. The customisation tool 91 can also add or remove a module for example. The customisation tool 91 can also modify the sequence 99 in which the candidate to be assessed interacts with the modules 98. The customisation tool 91 can add or remove a decision point and also modify the value of the criterion of the decision point. In addition, the customisation tool 91 can modify an association between a module and a factor such as by adding, removing or modifying a relation between a question of a module and a factor for example. The customisation tool 91 can also modify the factor. The customisation tool 91 can modify the factor weight table 60 by modifying the values of the factor weights of the sub-tables 64 and 66.

The customisation tool 91 can modify the constructs 96. The customisation tool 91 can modify an association between a construct and a factor such as by adding, removing or modifying a relation between a construct and a factor for example. The customisation tool 91 can also add or remove a construct. The customisation tool 91 can also modify the combination of factors with their respective factor weights thereby modifying a score of a construct. The customisation tool 91 can also add or remove a score of a construct by modifying the values of the factor weights of the sub-tables 64 and 66. In addition, the customisation tool 91 can modify the construct weight table thereby modifying a general score.

All the modifications to the custom assessment project 90 listed above are examples. Any kind of modification that could be made by the customisation tool 91 to an assessment project is contemplated.

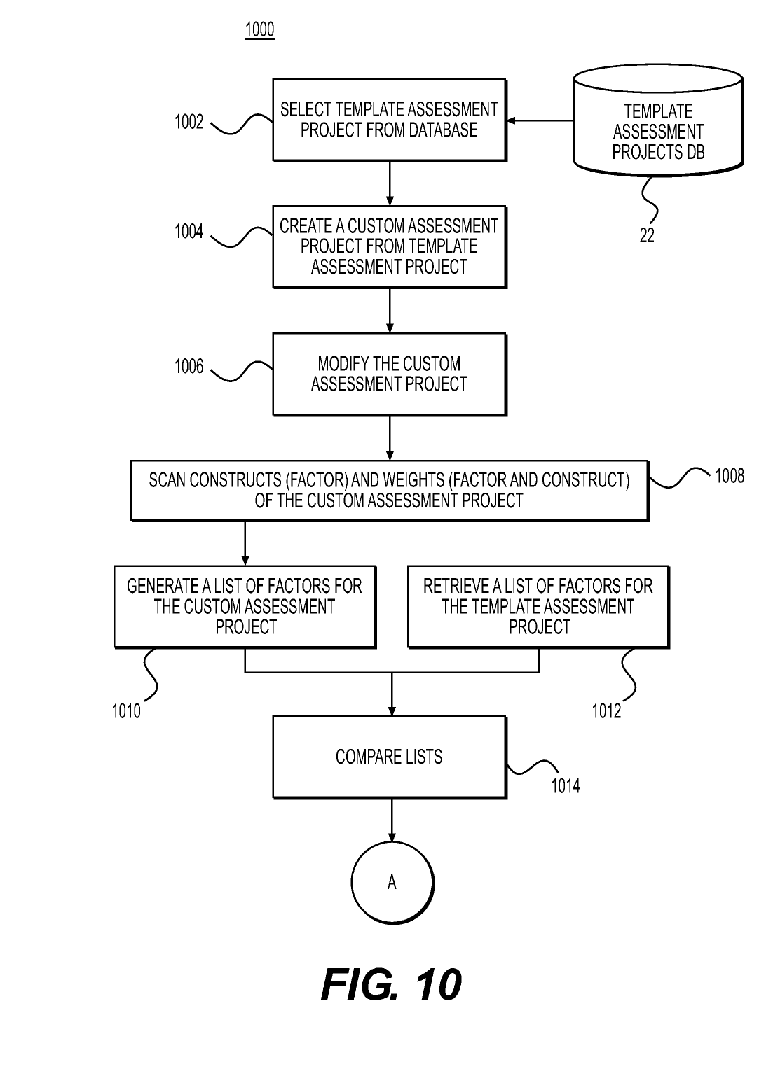

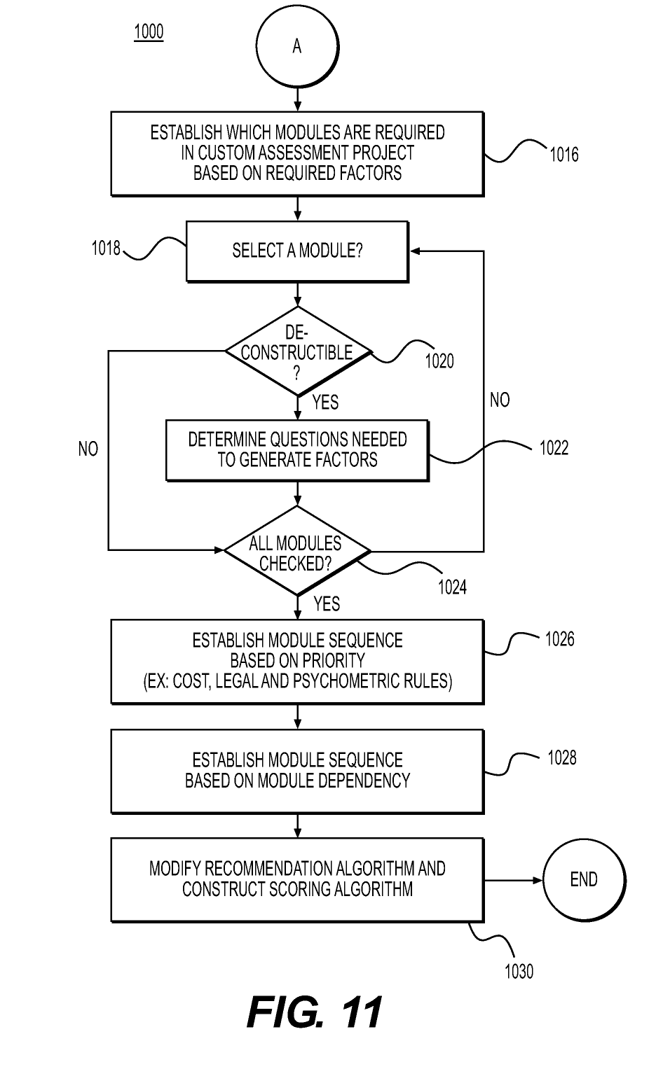

Turning now to FIGS. 10 and 11, where the steps of a method 1000 of updating a custom assessment project 90, according to an embodiment, will now be described. The method 1000 is undertaken by the customisation tool 91. The method 1000 begins at step 1002 where the user 19 selects a template assessment project 400 from the database 22. Next, at step 1004, the customisation tool 91 creates a custom assessment project 90 from the selected template assessment project 400. Next, at step 1006, the user 19 modifies the custom assessment project 90 in one of the way described above. Next, in response to the modification at step 1006, the customisation tool 91 scans and lists the constructs and the construct weights of the custom assessment project 90 in a construct table. Next, at step 1010, for each one of the constructs of the custom assessment project 90, a list of factors and factor weights associated with the factors is generated. Each list of factors is combined in a custom assessment project factor list. At step 1012, a factor list of the template assessment project 400 is retrieved. The template assessment project factor list can be pre-generated (i.e. retrieved from the database 22) or generated according to the steps 1008 and 1010 of the method 1000. Next, at step 1014, the customisation tool 91 compares the custom assessment project factor list with the template assessment project factor list.

At step 1016, the customisation tool 91 establishes which modules are required in the custom assessment project 90, based on required factors of at least one of the custom assessment project 90 and the template assessment project 400. At step 1018, one of the module is selected. At a decision point 1020, if the selected module is de-constructible, then the customisation tool 91 proceeds to step 1022. If the module is not de-constructible, then the customisation tool 91 proceeds to the decision point 1024. At step 1022, the customisation tool 91 determines which questions of the selected module are required to generate the required factors and modifies or removes the selected module accordingly. At decision point 1024, if all the modules have been checked, then the customisation tool 91 proceeds to step 1026. If not all the modules have been checked, then the customisation tool 91 returns to step 1018 to select a module that has not been checked/selected. At step 1026, the customisation tool 91 establishes a sequence of the modules based on priority criterions of the modules. At step 1028, the customisation tool 91 establishes a sequence of the modules based on dependency criterions of the modules. At step 1030, the customisation tool 91 modifies a calculation of the construct score based on factors weights and modifies a calculation of the general score based on construct weights.

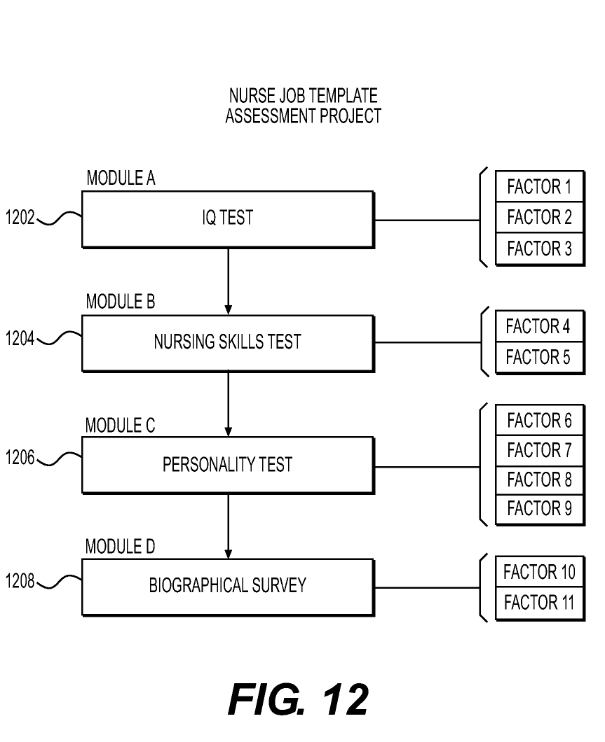

FIG. 12 illustrates an example of a nurse job template assessment project. The nurse job template assessment project comprises a module 1202 to carry out an IQ test associated with Factor 1, Factor 2, and Factor 3, a module 1204 to carry out a Nursing skills test associated with Factor 4 and Factor 5, a module 1206 to carry out a Personality test associated to Factor 6, Factor 7, Factor 8, and Factor 9, and a module 1208 to carry out a Biographical survey associated with Factor 10 and Factor 12. The nurse job template assessment project is selected by the user 19.

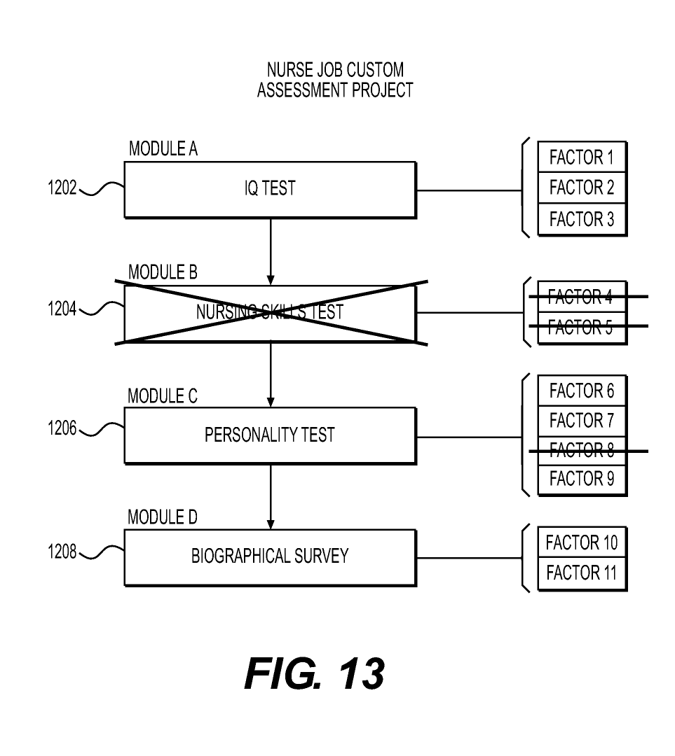

As shown in FIG. 13, the selected nurse job template assessment project is then used to create a nurse job custom assessment project, for example, to help select a new nurse for an acute care position in a hospital. The user 19, by using the customisation tool 91, customises the nurse job custom assessment project and modifies the profile and/or the workflow of the project to generate a nurse job custom assessment project specific to nurse job for the hospital. In the example of FIG. 13, the user 19 removes the module 1204 and removes the Factor 8 of the module 1206.

When the user 19 has completed the modifications to the nurse job custom assessment project, the customisation tool 91 updates the nurse job custom assessment project according to the method 1000. When the customisation tool 91 has completed the update, the nurse job custom assessment project is ready to be used for assessment of candidates.

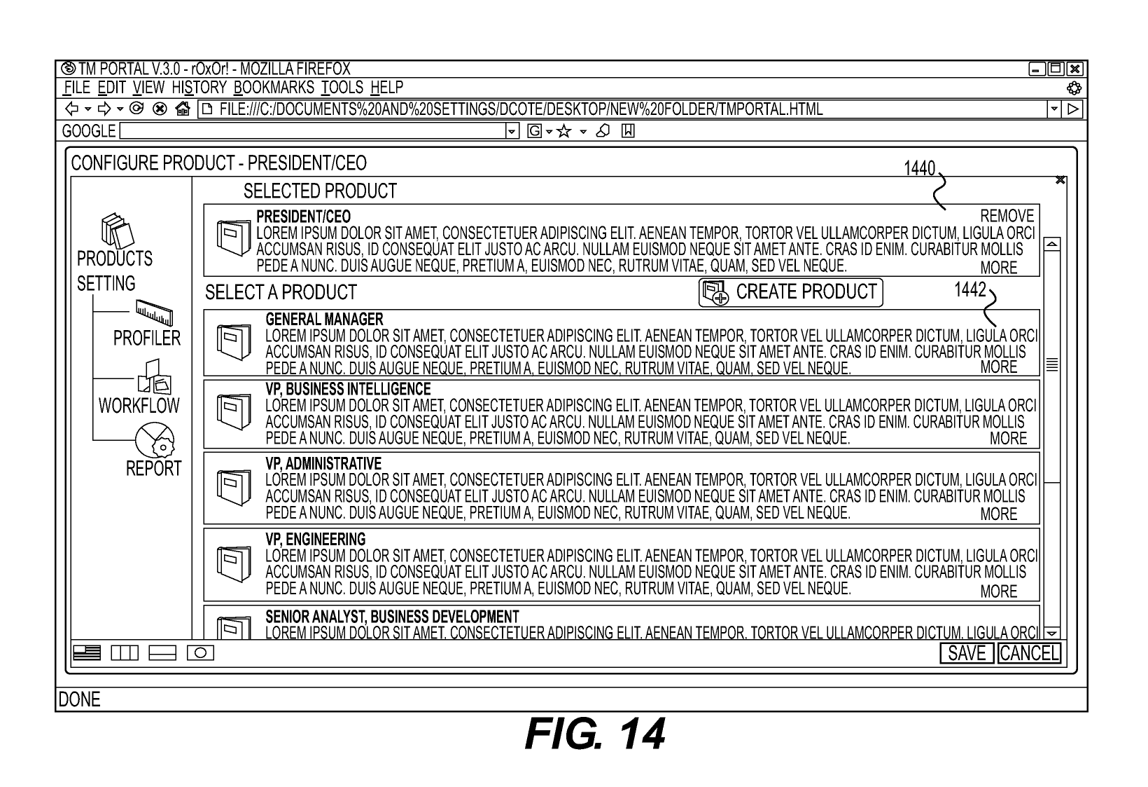

FIG. 14 illustrates a first window of the customisation tool 91 according to an embodiment. The first window depicts a first graphical user interface of the customisation tool 91 and has two main components. The first main component is an area 1440 where the selected template assessment project is displayed. In this example, the template assessment project “President/CEO” is selected. The second main component 1442 is a list that contains the different template assessment projects proposed. In this example, template assessment projects “General Manager”, “VP, Business Intelligence”, “VP, Administrative”, “VP, Engineering” and “Senior Analyst, Business Development” are proposed. Once the template assessment project is selected, the user 19 has the possibility, if it is required, to customise the template for specific needs of a project. If the user 19 decides to proceed with the customisation of the template, then the customisation tool 91 creates an override file, that stores all the modifications to a profile and a workflow of a custom assessment project. The override file forms the custom assessment project.

The first step of the customisation is directed to the customisation of the profile of the custom assessment project wherein two levels of customisation are proposed. At the first level, the user 19 can disable (or not) the different constructs that are contained in the custom assessment project for the purpose of the project. For example, the user 19 can make the decision that the construct “written communication” is not a skill relevant to the position and therefore disable it. At the second level, the user 19 can edit or add new content to the custom assessment project.

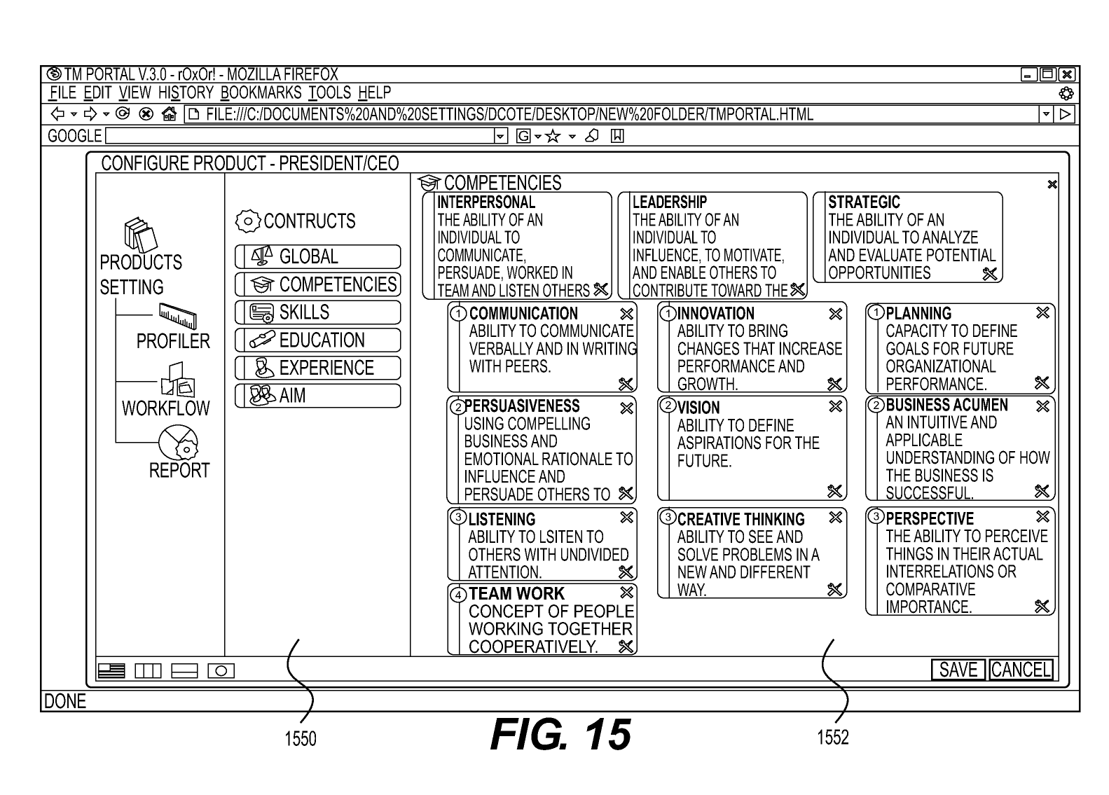

FIG. 15 illustrates a second window of the customisation tool 91 according to an embodiment. The second window depicts a second graphical user interface of the customisation tool 91 and has two main components. The first main component 1550 is a list that contains the different constructs of the custom assessment project. In this example, the constructs “Global”, “Competencies”, “Skills”, “Education”, “Experience” and “AIM” are proposed. The second main component 1552, in this example, displays the content of the construct “Competencies” which has been selected by the user. The content of the construct “Competencies”, in this example, includes “Interpersonal”, “Leadership” and “Strategic”. Each one of these competencies includes sub-components, such as “Communication”, “Persuasiveness” and “Listening” for the competence “Interpersonal”; “Innovation”, “Vision” and “Creative Thinking” for the competence “Leadership”; and “Planning”, “Business” and “Perspective” for the competence “Strategic”. As previously mentioned, at a first level of customization selected constructs can be disabled for the purposes of the specific project. At a second level, the user 19 can edit existing content or add new content to the constructs of the custom assessment project by modifying the workflow. Constructs and content are managed in a content management system.

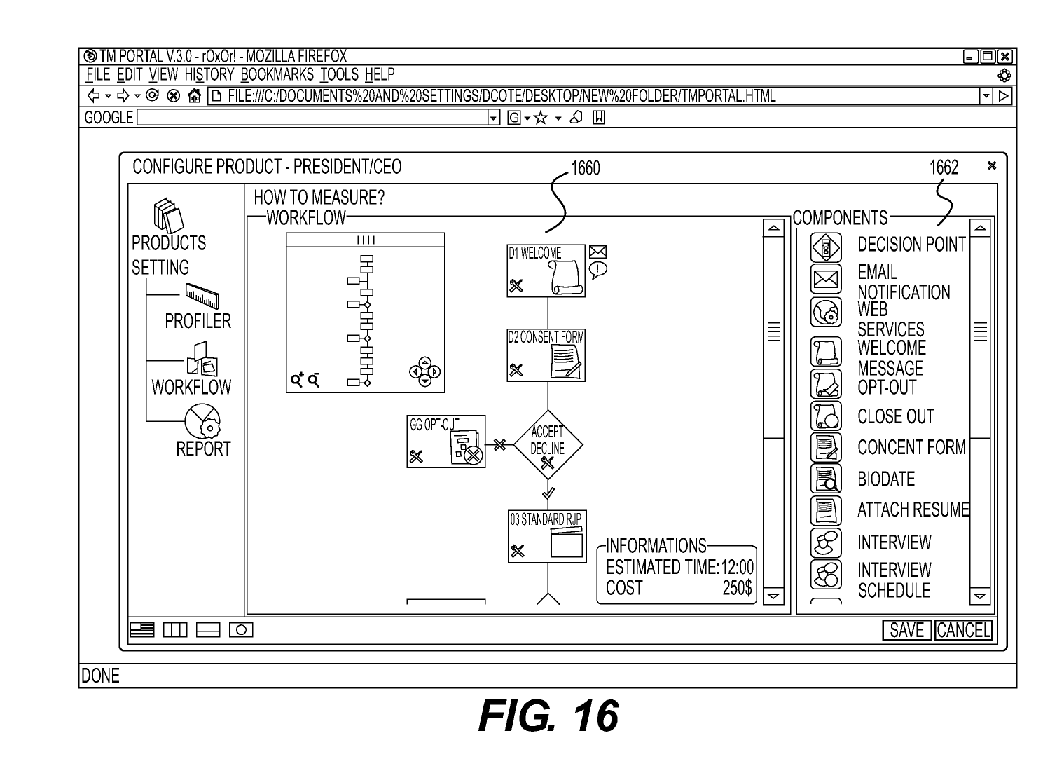

FIG. 16 illustrates a third window of the customisation tool 91 according to an embodiment. The third window depicts a third graphical user interface of the customisation tool 91 and has two main components. The first main component 1660 shows an example of workflow representing a candidate selection process. In this example, the candidate selection process comprises different modules and at least one go/no-go decision. The second main component 1662 shows an example of list of modules that can be used to define the workflow shown in the first main component 1660. As previously mentioned, the modules can be customised, a sequence of the workflow can also be customised.

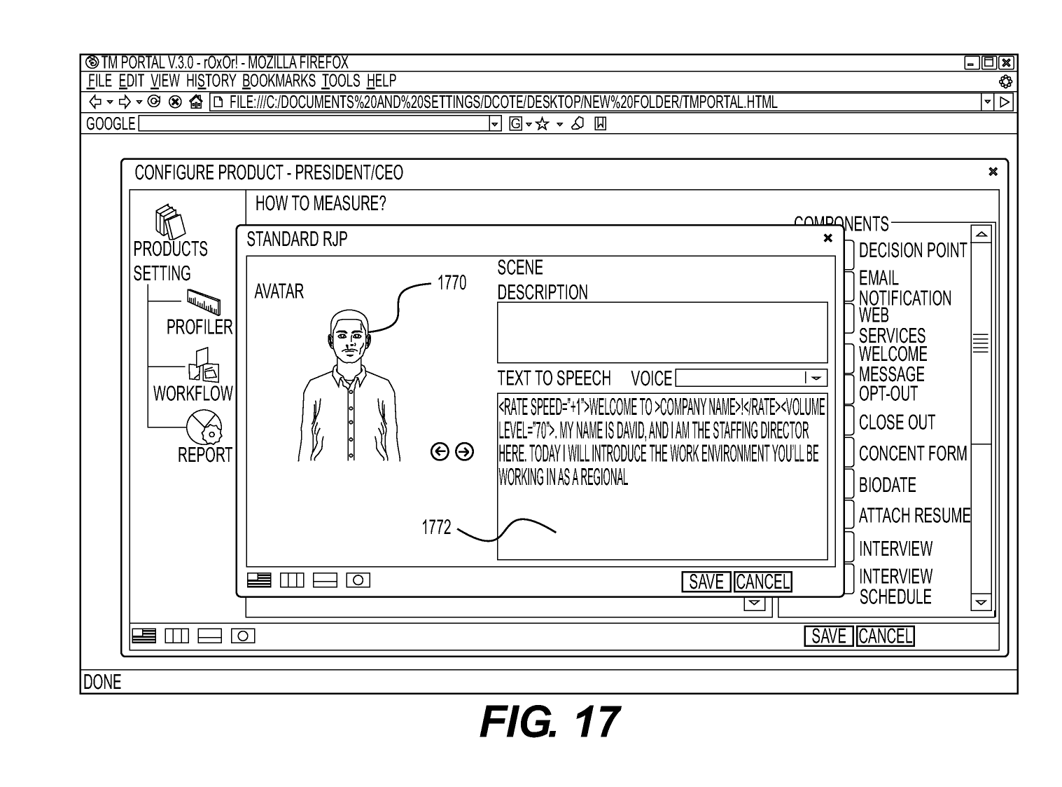

FIG. 17 illustrates a fourth window of the customisation tool 91 according to an embodiment. The fourth window depicts a fourth graphical user interface of the customisation tool 91 and has at least two main components. The first main component 1770 shows an embodiment of the step simulation in which an example of avatar is displayed. The second main component 1772 shows a window in which the text to be spoken by the avatar can be edited.

It will be appreciated that, in some embodiments, certain functionality of a given component described herein (including the assessment server 12, the customisation tool 91 or part thereof) may be implemented as pre-programmed hardware or firmware elements (e.g., application specific integrated circuits (ASICs), electrically erasable programmable read-only memories (EEPROMs), etc.) or other related elements. In other embodiments, a given component described herein (including the assessment server 12, the customisation tool 91 or part thereof) may comprise a processor having access to a code memory which stores program code (instructions) for operation of the processor to implement functionality of that given component. The program code may be stored on a medium which is fixed, tangible, and readable directly by the given component (e.g., removable diskette, CD-ROM, ROM, fixed disk, USB key, etc.). Alternatively, the program code may be stored remotely but transmittable to the given component via a modem or other interface device connected to a network over a transmission medium. The transmission medium may be either a tangible medium (e.g., optical or analog communications lines) or a medium implemented using wireless techniques (e.g., microwave, infrared or other wireless transmission schemes).

While the methods and system disclosed herein have been described and shown with reference to particular steps performed in a particular order, it will be understood that these steps may be combined, sub-divided, or re-ordered to form an equivalent method without departing from the teachings of the present invention. Accordingly, the order and grouping of the steps is not a limitation of the present invention.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. A method of creating a custom assessment project, the method comprising:
selecting a template assessment project from a database, the template assessment project including:
a first module and a second module, the first and second modules being adapted for interaction with a candidate to be assessed,
the first module being linked to the second module in a workflow, the workflow defining a sequence in which the candidate to be assessed interacts with the first and second modules,
a factor associated with at least one of the first and second modules,
a construct associated with the factor for evaluating an aspect of the candidate;
modifying at least one of the first module, the second module, the workflow, the factor, and the construct in response to user interaction; and
updating at least another one of the first module, the second module, the workflow, the factor, and the construct without user interaction in response to modifying the at least one of the first module, the second module, the workflow, the factor, and the construct.

2. The method of claim 1, wherein the factor is a first factor, the construct is a first construct, the aspect of the candidate is a first aspect;
wherein the template assessment project further includes a second factor, associated with at least one of the first and second modules;
wherein modifying at least one of the first module, the second module, the workflow, the factor, and the construct in response to user interaction includes adding a second construct in response to user interaction, the second construct being associated with one of the first and second factors for evaluating a second aspect of the candidate; and
wherein updating at least another one of the first module, the second module, the workflow, the factor, and the construct without user interaction is in response to adding the second construct.

3. The method of claim 1, wherein the factor is a first factor, the construct is a first construct, the aspect of the candidate is a first aspect;
wherein the template assessment project further includes:
a second factor, associated with at least one of the first and second modules; and
a second construct, the second construct being associated with at least one of the first and second factors for evaluating a second aspect of the candidate.

4. The method of claim 3, wherein modifying at least one of the first module, the second module, the workflow, the factor, and the construct in response to user interaction includes removing one of the first and second constructs in response to user interaction; and
wherein updating at least another one of the first module, the second module, the workflow, the factor, and the construct without user interaction is in response to removing the one of the first and second constructs.

5. The method of claim 1, wherein modifying at least one of the first module, the second module, the workflow, the factor, and the construct in response to user interaction includes removing one of the first and second modules in response to user interaction.

6. The method of claim 1, wherein modifying at least one of the first module, the second module, the workflow, the factor, and the construct in response to user interaction includes adding a third module in response to user interaction, the third module being adapted for interaction with the candidate to be assessed, the third module being linked to at least one of the first and second modules in the workflow; and
wherein updating at least another one of the first module, the second module, the workflow, the factor, and the construct without user interaction is in response to adding the third module.

7. The method of claim 1, wherein modifying at least one of the first module, the second module, the workflow, the factor, and the construct in response to user interaction includes modifying a factor weight associated with the factor in response to user interaction, the factor weight and the factor defining variables associated with a score associated with the construct.

8. The method of claim 7, wherein updating at least another one of the first module, the second module, the workflow, the factor, and the construct without user interaction in response to modifying the at least one of the first module, the second module, the workflow, the factor, and the construct comprises updating the factor weight.

9. The method of claim 7, wherein modifying at least one of the first module, the second module, the workflow, the factor, and the construct in response to user interaction includes modifying a construct weight associated with the score associated with the construct in response to user interaction, the construct weight and the score associated with the construct defining variables associated with a score associated with the candidate.

10. The method of claim 9, wherein updating at least another one of the first module, the second module, the workflow, the factor, and the construct without user interaction in response to modifying the at least one of the first module, the second module, the workflow, the factor, and the construct comprises updating the construct weight.

11. The method of claim 1, wherein modifying at least one of the first module, the second module, the workflow, the factor, and the construct in response to user interaction includes modifying the factor in response to user interaction.

12. The method of claim 11, wherein updating at least another one of the first module, the second module, the workflow, the factor, and the construct without user interaction in response to modifying the at least one of the first module, the second module, the workflow, the factor, and the construct includes:
comparing the factor of the template assessment project with the modified factor; and
determining if one of the first and second modules is to be modified; and
modifying a corresponding one of the first and second modules if one of the first and second modules is to be modified.

13. The method of claim 12, wherein modifying the corresponding one of the first and second modules if one of the first and second modules is to be modified includes removing the corresponding one of the first and second modules if one of the first and second modules is to be removed.

14. The method of claim 1, wherein each of the first and second modules comprises a priority criterion, the priority criterion defining a priority of the first and second modules in the sequence.

15. The method of claim 14, wherein updating at least another one of the first module, the second module, the workflow, the factor, and the construct without user interaction in response to modifying the at least one of the first module, the second module, the workflow, the factor, and the construct is based at least on the priority criterion.

16. The method of claim 1, wherein each of the first and second modules comprises a dependency criterion, the dependency criterion defining a dependency of the first and second modules in the sequence.

17. The method of claim 16, wherein updating at least another one of the first module, the second module, the workflow, the factor, and the construct without user interaction in response to modifying the at least one of the first module, the second module, the workflow, the factor, and the construct is based at least on the dependency criterion.

18. The method of claim 1, wherein the aspect of the candidate is one of a competency, a skill, an experience, a certification, knowledge, and an aptitude.

19. The method of claim 14, wherein the priority criterion is one of a cost criterion, a legal criterion, and a psychometric rule.

20. A system for creating a custom assessment project, the system comprising:
a database storing at least one template assessment project;
a selection component for selecting a template assessment project from the database, the template assessment project including:
a first module and a second module, the first and second modules being adapted for interaction with a candidate to be assessed,
the first module being linked to the second module in a workflow, the workflow defining a sequence in which the candidate to be assessed interacts with the first and second modules,
a factor associated with at least one of the first and second modules,
a construct associated with the factor for evaluating an aspect of the candidate;
an interface allowing a user to modify at least one of the first module, the second module, the workflow, the factor, and the construct; and
a customisation tool for updating at least another one of the first module, the second module, the workflow, the factor, and the construct without user interaction in response to modifying the at least one of the first module, the second module, the workflow, the factor, and the construct.

21. The system of claim 20, wherein the factor is a first factor, the construct is a first construct, the aspect of the candidate is a first aspect;
wherein the template assessment project further includes a second factor, associated with at least one of the first and second modules;
wherein the interface allowing the user to modify at least one of the first module, the second module, the workflow, the factor, and the construct includes an interface allowing the user to add a second construct, the second construct being associated with one of the first and second factors for evaluating a second aspect of the candidate; and
wherein the customisation tool updates at least another one of the first module, the second module, the workflow, the factor, and the construct without user interaction in response to adding the second construct.

22. The system of claim 20, wherein the factor is a first factor, the construct is a first construct, the aspect of the candidate is a first aspect;
wherein the template assessment project further includes:
a second factor, associated with at least one of the first and second modules; and
a second construct, the second construct being associated with at least one of the first and second factors for evaluating a second aspect of the candidate.

23. The system of claim 22, wherein the interface allowing the user to modify at least one of the first module, the second module, the workflow, the factor, and the construct includes an interface allowing the user to remove one of the first and second constructs; and
wherein the customisation tool updates at least another one of the first module, the second module, the workflow, the factor, and the construct without user interaction in response to removing the one of the first and second constructs.

24. The system of claim 20, wherein the interface allowing the user to modify at least one of the first module, the second module, the workflow, the factor, and the construct includes an interface allowing the user to remove one of the first and second modules.

25. The system of claim 20, wherein the interface allowing the user to modify at least one of the first module, the second module, the workflow, the factor, and the construct includes an interface allowing the user to add a third module, the third module being adapted for interaction with the candidate to be assessed, the third module being linked to at least one of the first and second modules in the workflow; and
wherein the customisation tool updates at least another one of the first module, the second module, the workflow, the factor, and the construct without user interaction in response to adding the third module.

26. The system of claim 20, wherein the interface allowing the user to modify at least one of the first module, the second module, the workflow, the factor, and the construct includes an interface allowing the user to modify a factor weight associated with the factor, the factor weight and the factor defining variables associated with a score associated with the construct.

27. The system of claim 26, wherein the interface allowing the user to modify at least one of the first module, the second module, the workflow, the factor, and the construct includes an interface allowing the user to modify a construct weight associated with the score associated with the construct, the construct weight and the score associated with the construct defining variables associated with a score associated with the candidate.

28. The system of claim 20, wherein the interface allowing the user to modify at least one of the first module, the second module, the workflow, the factor, and the construct includes an interface allowing the user to modify the factor.

29. The system of claim 28, wherein the customisation tool for updating at least another one of the first module, the second module, the workflow, the factor, and the construct without user interaction in response to modifying the at least one of the first module, the second module, the workflow, the factor, and the construct:
compares the factor of the template assessment project with the modified factor; and
determines if one of the first and second modules is to be modified; and
modifies a corresponding one of the first and second modules if one of the first and second modules is to be modified.

30. The system of claim 29, wherein modifying the corresponding one of the first and second modules if one of the first and second modules is to be modified includes removing the corresponding one of the first and second modules if one of the first and second modules is to be removed.

31. The system of claim 20, wherein each of the first and second modules comprises a priority criterion, the priority criterion defining a priority of the first and second modules in the sequence.

32. The system of claim 31, wherein the customisation tool updates at least another one of the first module, the second module, the workflow, the factor, and the construct without user interaction in response to modifying the at least one of the first module, the second module, the workflow, the factor, and the construct based at least on the priority criterion.

33. The system of claim 20, wherein each of the first and second modules comprises a dependency criterion, the dependency criterion defining a dependency of the first and second modules in the sequence.

34. The system of claim 33, wherein the customisation tool updates at least another one of the first module, the second module, the workflow, the factor, and the construct without user interaction in response to modifying the at least one of the first module, the second module, the workflow, the factor, and the construct based at least on the dependency criterion.

35. The system of claim 20, wherein the aspect of the candidate is one of a competency, a skill, an experience, a certification, knowledge, and an aptitude.

36. The system of claim 31, wherein the priority criterion is one of a cost criterion, a legal criterion, and a psychometric rule.

37. A computer readable storage medium containing program code for execution by a computing entity to implement a method of creating a custom assessment project, the method comprising:
selecting a template assessment project from a database, the template assessment project including:
a first module and a second module, the first and second modules being adapted for interaction with a candidate to be assessed,
the first module being linked to the second module in a workflow, the workflow defining a sequence in which the candidate to be assessed interacts with the first and second modules,
a factor associated with at least one of the first and second modules,
a construct associated with the factor for evaluating an aspect of the candidate;
modifying at least one of the first module, the second module, the workflow, the factor, and the construct in response to user interaction; and
updating at least another one of the first module, the second module, the workflow, the factor, and the construct without user interaction in response to modifying the at least one of the first module, the second module, the workflow, the factor, and the construct.

38. The computer readable storage medium of claim 37, wherein the factor is a first factor, the construct is a first construct, the aspect of the candidate is a first aspect;
wherein the template assessment project further includes a second factor, associated with at least one of the first and second modules;
wherein modifying at least one of the first module, the second module, the workflow, the factor, and the construct in response to user interaction includes adding a second construct in response to user interaction, the second construct being associated with one of the first and second factors for evaluating a second aspect of the candidate; and
wherein updating at least another one of the first module, the second module, the workflow, the factor, and the construct without user interaction is in response to adding the second construct.

39. The computer readable storage medium of claim 37, wherein the factor is a first factor, the construct is a first construct, the aspect of the candidate is a first aspect;
wherein the template assessment project further includes:
a second factor, associated with at least one of the first and second modules; and
a second construct, the second construct being associated with at least one of the first and second factors for evaluating a second aspect of the candidate.

40. The computer readable storage medium of claim 39, wherein modifying at least one of the first module, the second module, the workflow, the factor, and the construct in response to user interaction includes removing one of the first and second constructs in response to user interaction; and
wherein updating at least another one of the first module, the second module, the workflow, the factor, and the construct without user interaction is in response to removing the one of the first and second constructs.

41. The computer readable storage medium of claim 37, wherein modifying at least one of the first module, the second module, the workflow, the factor, and the construct in response to user interaction includes removing one of the first and second modules in response to user interaction.

42. The computer readable storage medium of claim 37, wherein modifying at least one of the first module, the second module, the workflow, the factor, and the construct in response to user interaction includes adding a third module in response to user interaction, the third module being adapted for interaction with the candidate to be assessed, the third module being linked to at least one of the first and second modules in the workflow; and
wherein updating at least another one of the first module, the second module, the workflow, the factor, and the construct without user interaction is in response to adding the third module.

43. The computer readable storage medium of claim 37, wherein modifying at least one of the first module, the second module, the workflow, the factor, and the construct in response to user interaction includes modifying a factor weight associated with the factor in response to user interaction, the factor weight and the factor defining variables associated with a score associated with the construct.

44. The computer readable storage medium of claim 43, wherein updating at least another one of the first module, the second module, the workflow, the factor, and the construct without user interaction in response to modifying the at least one of the first module, the second module, the workflow, the factor, and the construct comprises updating the factor weight.

45. The computer readable storage medium of claim 43, wherein modifying at least one of the first module, the second module, the workflow, the factor, and the construct in response to user interaction includes modifying a construct weight associated with the score associated with the construct in response to user interaction, the construct weight and the score associated with the construct defining variables associated with a score associated with the candidate.

46. The computer readable storage medium of claim 45, wherein updating at least another one of the first module, the second module, the workflow, the factor, and the construct without user interaction in response to modifying the at least one of the first module, the second module, the workflow, the factor, and the construct comprises updating the construct weight.

47. The computer readable storage medium of claim 37, wherein modifying at least one of the first module, the second module, the workflow, the factor, and the construct in response to user interaction includes modifying the factor in response to user interaction.

48. The computer readable storage medium of claim 47, wherein updating at least another one of the first module, the second module, the workflow, the factor, and the construct without user interaction in response to modifying the at least one of the first module, the second module, the workflow, the factor, and the construct includes:
comparing the factor of the template assessment project with the modified factor; and
determining if one of the first and second modules is to be modified; and
modifying a corresponding one of the first and second modules if one of the first and second modules is to be modified.

49. The computer readable storage medium of claim 48, wherein modifying the corresponding one of the first and second modules if one of the first and second modules is to be modified includes removing the corresponding one of the first and second modules if one of the first and second modules is to be removed.

50. The computer readable storage medium of claim 37, wherein each of the first and second modules comprises a priority criterion, the priority criterion defining a priority of the first and second modules in the sequence.

51. The computer readable storage medium of claim 50, wherein updating at least another one of the first module, the second module, the workflow, the factor, and the construct without user interaction in response to modifying the at least one of the first module, the second module, the workflow, the factor, and the construct is based at least on the priority criterion.

52. The computer readable storage medium of claim 37, wherein each of the first and second modules comprises a dependency criterion, the dependency criterion defining a dependency of the first and second modules in the sequence.

53. The computer readable storage medium of claim 52, wherein updating at least another one of the first module, the second module, the workflow, the factor, and the construct without user interaction in response to modifying the at least one of the first module, the second module, the workflow, the factor, and the construct is based at least on the dependency criterion.

54. The computer readable storage medium of claim 37, wherein the aspect of the candidate is one of a competency, a skill, an experience, a certification, knowledge, and an aptitude.

55. The computer readable storage medium of claim 50, wherein the priority criterion is one of a cost criterion, a legal criterion, and a psychometric rule.

56. The method of claim 1, wherein modifying at least one of the first module, the second module, the workflow, the factor, and the construct in response to user interaction is achieved by a user interface.

57. The method of claim 1, wherein updating at least another one of the first module, the second module, the workflow, the factor, and the construct without user interaction in response to modifying the at least one of the first module, the second module, the workflow, the factor, and the construct is achieved by a customisation tool.

58. The computer readable storage medium of claim 37, wherein modifying at least one of the first module, the second module, the workflow, the factor, and the construct in response to user interaction is achieved by a user interface.

59. The computer readable storage medium of claim 37, wherein updating at least another one of the first module, the second module, the workflow, the factor, and the construct without user interaction in response to modifying the at least one of the first module, the second module, the workflow, the factor, and the construct is achieved by a customisation tool.
